(19) United States
(12) Patent Application Publication
(10) Pub. No.: US 2015/0229017 A1
(43) Pub. Date: Aug. 13, 2015

(54) HIGH FREQUENCY MODULE AND FABRICATION METHOD FOR HIGH FREQUENCY MODULE

(71) Applicant: FUJITSU LIMITED, Kawasaki-shi (JP)

(72) Inventors: Toshihide Suzuki, Zama (JP); Shinya Sasaki, Ebina (JP); Koji Nozaki, Atsugi (JP)

(21) Appl. No.: 14/571,469

(22) Filed: Dec. 16, 2014

(30) Foreign Application Priority Data
Feb. 7, 2014 (JP) 2014-022530

(51) Int. Cl. H01P 5/107; H01P 11/00

(52) U.S. Cl. CPC H01P 5/085; H01P 11/003

(57) ABSTRACT

A high frequency module includes a metal housing including a waveguide, and a package unit that includes a back short positioned on an extension of the waveguide, a semiconductor chip, and an antenna coupler positioned between the waveguide and the back short and in which the back short and the semiconductor chip are integrated by resin and the antenna coupler and the semiconductor chip are electrically coupled with each other by a redistribution line.

### CROSS-REFERENCE TO RELATED APPLICATION

This application is based upon and claims the benefit of priority of the prior Japanese Patent Application No. 2014-022530, filed on Feb. 7, 2014, the entire contents of which are incorporated herein by reference.

### FIELD

The embodiments discussed herein are related to a high frequency module and a fabrication method for a high frequency module.

### BACKGROUND

A coaxial connector cable marketed at present has a transmission frequency whose upper limit is 110 GHz, and a waveguide is used for transmission of a higher frequency signal than the frequency just mentioned. Further, in order to transmit a high frequency signal between a waveguide and a semiconductor chip, a microstrip line board is used to convert a signal into a planar transmission line. In short, a waveguide-microstrip line converter is used. Further, a semiconductor chip is mounted on the waveguide-microstrip line converter, and the semiconductor chip and the microstrip line board are coupled with each other by wire bonding, flip chip bonding or the like.

For example, as depicted in FIGS. 17A and 17B, a microstrip line board 102 is mounted in a space continuous to a waveguide 101 in the inside of a metal housing 100 so as to project into the inside of the waveguide 101. Further, a semiconductor chip 103 is mounted and is coupled by wire bonding, flip chip bonding or the like.

### SUMMARY

According to an aspect of the embodiment, a high frequency module includes a metal housing including a waveguide, and a package unit that includes a back short positioned on an extension of the waveguide, a semiconductor chip, and an antenna coupler positioned between the waveguide and the back short and in which the back short and the semiconductor chip are integrated by resin and the antenna coupler and the semiconductor chip are electrically coupled with each other by a redistribution line.

According to another aspect of the embodiment, a fabrication method for a high frequency module includes fabricating a package unit including a back short, a semiconductor chip and an antenna coupler, and attaching the package unit to a metal housing including a waveguide such that the back short is positioned on an extension of the waveguide and the antenna coupler is positioned between the waveguide and the back short, and wherein the fabricating the package unit includes integrating the back short and the semiconductor chip by resin, and providing a redistribution line such that the antenna coupler and the semiconductor chip are electrically coupled with each other.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic sectional view depicting a configuration of a high frequency module according to a first embodiment;

FIGS. 2A and 2B are schematic views depicting a configuration of a package unit provided in the high frequency module according to the first embodiment, wherein FIG. 2A is a top plan view and FIG. 2B is a sectional view taken along line A-A′ of FIG. 2A;

FIGS. 3A and 3B are schematic views depicting a configuration of a package unit of a first modification provided in the high frequency module according to the first embodiment, wherein FIG. 3A is a top plan view and FIG. 3B is a sectional view taken along line A-A′ of FIG. 3A;

FIGS. 4A and 4B are schematic views depicting a configuration of a package unit of a second modification provided in the high frequency module according to the first embodiment, wherein FIG. 4A is a top plan view and FIG. 4B is a sectional view taken along line A-A′ of FIG. 4A;

FIG. 5 is a schematic sectional view depicting a configuration a package unit of a different modification provided in the high frequency module according to the first embodiment;

FIGS. 6A and 6B are schematic views illustrating a fabrication method for the high frequency module (fabrication method for the package unit) according to the first embodiment, wherein FIG. 6A is a top plan view and FIG. 6B is a sectional view taken along line A-A′ of FIG. 6A;

FIGS. 7A to 7C are schematic sectional views illustrating the fabrication method for the high frequency module (fabrication method for the package unit) according to the first embodiment;

FIG. 8 is a schematic sectional view depicting a configuration of a high frequency module according to a second embodiment;

FIG. 9 is a schematic sectional view depicting a configuration of a dielectric film including a conductor layer configuring a package unit of the high frequency module according to the second embodiment;

FIGS. 10A to 10C, 11A to 11C and 12A and 12B are schematic sectional views illustrating a fabrication method for the high frequency module (fabrication method for the package unit) according to the second embodiment;

FIGS. 13A and 13B are schematic views depicting a configuration of a high frequency module according to a third embodiment, wherein FIG. 13A is a sectional view and FIG. 13B is a partial perspective view;

FIGS. 14A to 14L are schematic perspective views depicting examples of a configuration of a dielectric supporting member provided in a package unit of the high frequency module according to the third embodiment;

FIGS. 15A to 15E are schematic sectional views illustrating a fabrication method for the high frequency module (fabrication method for the package unit) according to the third embodiment;

FIGS. 16A to 16F are schematic views illustrating the fabrication method for the high frequency module (fabrication method for the package unit) according to the third embodiment, wherein FIGS. 16A to 16E are sectional views and FIG. 16F is a perspective view; and

FIGS. 17A and 17B are schematic sectional views depicting a configuration of a general high frequency module, wherein FIG. 17A depicts the high frequency module in a case in which wire bonding is used and FIG. 17B depicts the high frequency module in a case in which flip chip bonding is used.

### DESCRIPTION OF EMBODIMENTS

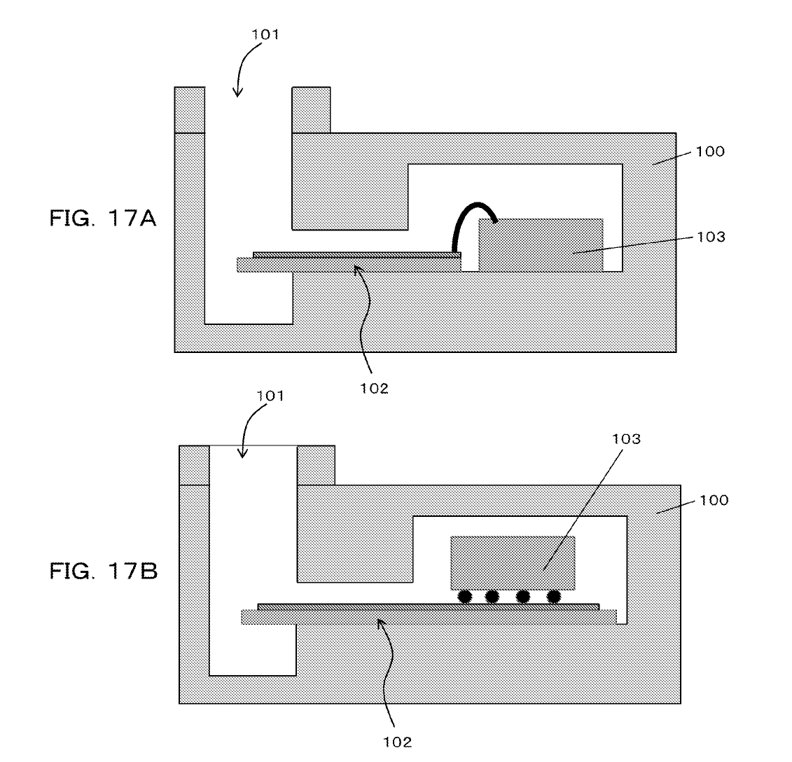

However, in the configurations depicted in FIGS. 17A and 17B, since a high frequency signal is transmitted through a microstrip line and wire bonding, flip chip bonding or the like, degradation of a high frequency characteristic when a high frequency signal is transmitted between the waveguide and the semiconductor chip is great.

For example, since the microstrip line extending from the waveguide to the semiconductor chip naturally becomes long and the microstrip line is coupled with the semiconductor chip by wire bonding, flip chip bonding or the like, signal loss caused by line resistance is great. Further, while the wavelength decreases as the frequency of a signal to be transmitted increases, if the length of the microstrip line to the semiconductor chip exceeds ¼ of the wavelength, then also waveform degradation arising from signal reflection occurs. Therefore, degradation of a high frequency characteristic when a high frequency signal is transmitted between the waveguide and the semiconductor chip is great.

Therefore, it is desired to reduce degradation of a high frequency characteristic when a high frequency signal is transmitted between the waveguide and the semiconductor chip.

In the following, a high frequency module and a fabrication method for the high frequency module according to embodiments are described with reference to the drawings.

### First Embodiment

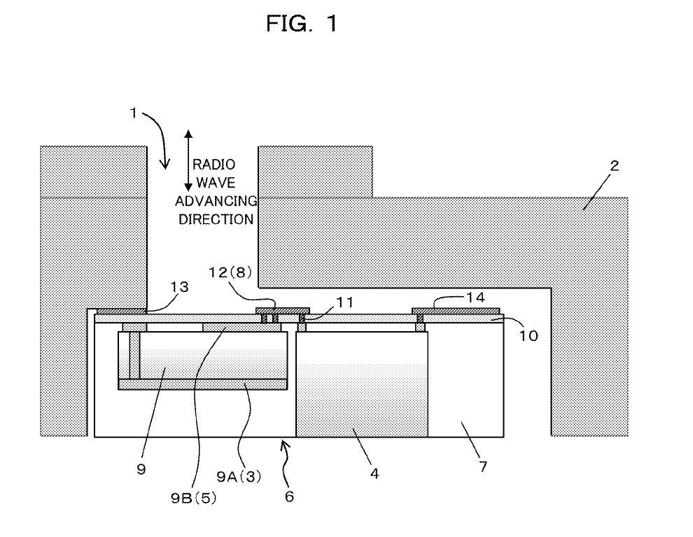

First, a high frequency module and a fabrication method for the high frequency module according to a first embodiment are described with reference to FIGS. 1 to 7C.

The high frequency module according to the present embodiment is mounted on a radar, a sensor or a wireless communication system for which a high frequency such as, for example, a millimeter wave or a terahertz wave is used.

As depicted in FIG. 1, the high frequency module according to the present embodiment includes a metal housing 2 having a waveguide 1 and a package unit 6 including a back short 3, a semiconductor chip 4 and an antenna coupler 5.

Here, the package unit 6 includes the back short 3 positioned on an extension of the waveguide 1, the semiconductor chip 4 and the antenna coupler 5 positioned between the waveguide 1 and the back short 3. Further, the back short 3 and the semiconductor chip 4 are integrated by resin 7. Further, the antenna coupler 5 and the semiconductor chip 4 are electrically coupled with each other by a redistribution line 8.

In this manner, the package unit 6 integrated by the resin 7 and coupled (connected) by the redistribution line 8 is attached to the metal housing 2 having the waveguide 1 such that the back short 3 is positioned on an extension of the waveguide 1 and the antenna coupler 5 is positioned between the waveguide 1 and the back short 3.

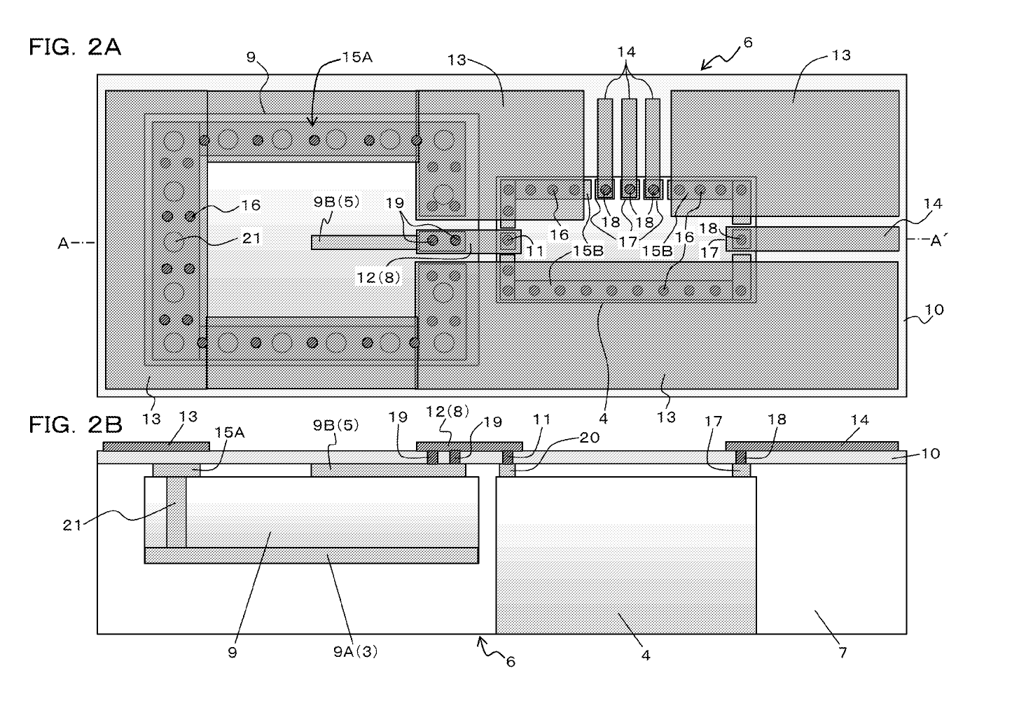

In the present embodiment, as depicted in FIGS. 1, 2A and 2B, the back short 3 is a back face conductor layer 9A provided on a back face of a multilayer dielectric substrate 9 (for example, of silica glass or the like). Further, the antenna coupler 5 is a front face conductor layer 9B provided on a front face of the multilayer dielectric substrate 9 at the opposite side to the back face. In particular, the package unit 6 includes the multilayer dielectric substrate 9 (passive element; passive part) including the back face conductor layer 9A that functions as the back short 3 and the front face conductor layer 9B that functions as the antenna coupler 5.

In this case, the distance between the antenna coupler 5 and the back short 3 is set with high accuracy to ¼ the wavelength λ (λ/4) of a high frequency signal to be transmitted depending upon the thickness and the pattern accuracy of the multilayer dielectric substrate 9. Here, the back short 3 is a ground face provided at the back side of the antenna coupler 5 and spaced away from the antenna coupler 5 by λ/4.

Further, the multilayer dielectric substrate 9 and the semiconductor chip 4 are integrated by the resin 7.

Further, in the present embodiment, the redistribution line 8 is configured from a line conductor 12 electrically coupled with the semiconductor chip 4 through a via 11 provided on a resin layer 10 formed on the resin 7. Here, the line conductor 12 as the redistribution line 8 is electrically coupled with the semiconductor chip 4 through the via 11 and is electrically coupled with the antenna coupler 5 (here, with the front face conductor layer 9B of the multilayer dielectric substrate 9) through a via 19. Further, the resin layer 10 is a photosensitive resin layer. Further, the line conductor 12 is a metal line (interconnection) formed from metal such as, for example, copper.

The redistribution line 8 having such a configuration as described above may be formed by metal plating using, for example, a semi-additive method or may be formed from metal paste (for example, from copper paste or silver paste) using an inkjet method. However, if the cost and the accuracy of mounting are taken into consideration, then it is preferable to form the redistribution line 8 by metal plating using the semi-additive method.

The package unit 6 in which the multilayer dielectric substrate 9 and the semiconductor chip 4 are buried with the mold resin 7 and integrated by the mold resin 7 with the positions thereof fixed, and the redistribution line 8 is formed on the integrated components to couple the antenna coupler 5 and the semiconductor chip 4 with each other in this manner is joined with the metal housing 2 from the rear side in such a manner that one end portion of the waveguide 1 of the metal housing 2 is closed up by the package unit 6 as depicted in FIG. 1. In short, the multilayer dielectric substrate 9 and the semiconductor chip 4 are integrated by the mold resin 7 and the antenna coupler 5 and the semiconductor chip 4 are coupled with each other by the redistribution line 8 using a dissimilar device integration technology and a redistribution technology.

In this manner, the package unit 6 in which the multilayer dielectric substrate 9 including the back short 3 and the semiconductor chip 4 are buried with the mold resin 7 and integrated by the mold resin 7 with the positions thereof fixed, and the redistribution line 8 is formed on the integrated components to couple the antenna coupler 5 and the semiconductor chip 4 with each other is joined with the metal housing 2 from the rear side of the back sort 3 in such a manner that one end portion of the waveguide 1 of the metal housing 2 is closed up by the package unit 6 as depicted in FIG. 1. In short, the multilayer dielectric substrate 9 and the semiconductor chip 4 are integrated by the mold resin 7 and the antenna coupler 5 and the semiconductor chip 4 are coupled with each other by the redistribution line 8 using a dissimilar device integration technology and a redistribution technology.

The processes from the waveguide-line conversion (coaxial conversion) to the mounting of the semiconductor chip are implemented by bonding (laminating) the package unit 6 that is produced in such a manner as described above and in which the back short 3, antenna coupler 5 and semiconductor chip 4 are integrated to the metal housing 2 so as to close up one end portion of the waveguide 1 of the metal housing 2 in this manner.

In the case of the high frequency module depicted in FIGS. 1, 2A and 2B, in order to transmit a high frequency signal between the waveguide 1 and the semiconductor chip 4, the front face conductor layer 9B of the multilayer dielectric substrate 9 as the antenna coupler 5 and the redistribution line 8 are used and the length of the front face conductor layer 9B and redistribution line 8 can be set short. In particular, the distance between the antenna coupler 5 (conversion unit) and the semiconductor chip 4 can be made short and the transmission line can be made short. Therefore, transmission loss, namely, signal loss (line loss) arising from line resistance, can be reduced. Further, while the wavelength decreases as the frequency of a signal to be transmitted increases, also in this case, the length up to the semiconductor chip 4 can be made shorter than ¼ the wavelength and waveform degradation arising from signal reflection can be reduced. For example, even in the case in which a high frequency signal of a super high frequency such as, for example, a millimeter wave or a terahertz wave is to be transmitted, also waveform degradation arising from signal reflection can be reduced. For example, the wavelength of a high frequency signal of approximately 100 GHz and the wavelength of a high frequency signal of approximately 300 GHz become short to approximately 3 mm and approximately 1 mm, respectively. Also in such a case as just described, the length up to the semiconductor chip 4 can be made shorter than ¼ the wavelength and also waveform degradation arising from signal reflection can be reduced. Consequently, degradation of a high frequency characteristic when a high frequency signal is transmitted (inputted and outputted) between the waveguide 1 and the semiconductor chip 4 can be reduced. In short, degradation of a high frequency characteristic in a transmission line extending from the semiconductor chip 4 to the waveguide 1 can be suppressed.

Further, since the package unit 6 in which the back short 3, antenna coupler 5 and semiconductor chip 4 are integrated is produced and is bonded to the metal housing 2 so as to close up one end portion of the waveguide 1 of the metal housing 2, the mounting accuracy of the antenna coupler 5 with respect to the waveguide 1 or the back short 3 is improved. In particular, the distance between the back short 3 and the antenna coupler 5 can be set with high accuracy to the distance of ¼ the wavelength of a high frequency signal to be transmitted depending upon the thickness and pattern accuracy of the multilayer dielectric substrate 9. Further, since the distance between the back short 3 and the antenna coupler 5 can be set with high accuracy, when the package unit 6 and the metal housing 2 are to be bonded, only if positioning in a horizontal direction is performed, then the positioning of them can be performed with high accuracy. Therefore, the mounting accuracy of the antenna coupler 5 with respect to the waveguide 1 or the back short 3 is improved. Consequently, such a situation can be reduced that a characteristic is drastically changed by a mounting error, processing variation or the like, and also the conversion efficiency of the waveguide-line conversion can be raised.

On the other hand, where a microstrip line board is used as in a traditional technology (for example, refer to FIGS. 17A and 17B), a characteristic (electrical characteristic) significantly varies depending upon processing variation or mounting accuracy of the microstrip line board. For example, where a high frequency signal of a super high frequency such as, for example, a millimeter wave or a terahertz wave is transmitted, the size of a waveguide or the distance from a microstrip line to a back short becomes that of an order substantially equal to the thickness or the width of the microstrip line board. For example, the wavelength of a high frequency signal of approximately 100 GHz and the wavelength of a high frequency signal of approximately 300 GHz become as short as approximately 3 mm and approximately, 1 mm, respectively, and the thickness or the width of the microstrip line board becomes so great that it cannot be ignored with respect to the wavelength. Therefore, a characteristic significantly varies depending upon the processing variation of the microstrip line board. Further, when the microstrip line board is mounted, it is significant to perform positioning in a vertical direction and a horizontal direction taking the distance between the microstrip line and the back short and the projection length of the microstrip line board into the waveguide into consideration, and it is difficult to perform the positioning with high accuracy. Therefore, the characteristic varies by a great amount depending upon mounting accuracy (processing error and mounting error) of the microstrip line board.

Further, the processes from the waveguide-line conversion to the mounting of the semiconductor chip are implemented by bonding the package unit 6 in which the back short 3, antenna coupler 5 and semiconductor chip 4 are integrated to the metal housing 2 so as to close up one end portion of the waveguide 1 of the metal housing 2. Therefore, also downsizing and reduction of loss can be implemented.

Further, in the present embodiment, in addition to the redistribution line 8 (redistribution signal line) to couple the antenna coupler 5 and a signal input-output terminal 20 of the semiconductor chip 4 with each other, as depicted in FIGS. 2A and 2B, for example, a redistribution ground portion 13 coupled with a ground terminal 15A coupled with the back short 3 or a ground terminal 15B of the semiconductor chip 4 through a via 16 and a redistribution signal line 14 coupled with a different signal input/output terminal 17 of the semiconductor chip 4 through a via 18 are formed. It is to be noted here that the back short 3 is coupled with the ground terminal 15A through a ground line 21. Further, the metal housing 2 is bonded on the redistribution ground portion 13 (refer to FIG. 1) and a gap (air gap) is formed only over the redistribution signal lines 8 and 14. Especially, a gap is formed only over the redistribution line 8 in the region in which a high frequency signal is transmitted between the antenna coupler 5 and the semiconductor chip 4. Since the gap is small, it is possible to reduce leakage and propagation of a radio wave (signal) in a waveguide mode.

On the other hand, where a microstrip line board is used as in a traditional technology (for example, refer to FIGS. 17A and 17B), it is significant to mount the microstrip line board in a space continuous to a waveguide in the inside of a metal housing. Therefore, since a great gap is produced over the microstrip line board, it is difficult to reduce leakage and propagation of a radio wave in a waveguide mode. Further, since there is a limit to reduction of the thickness in order to secure the strength of the microstrip line board, also it is difficult to reduce leakage and propagation of a radio wave through a substrate portion at the lower side of the microstrip line.

It is to be noted that the semiconductor chip 4 is referred to sometimes as circuit chip, semiconductor circuit chip or semiconductor integrated circuit chip. Further, the antenna coupler 5 is referred to sometimes as conversion coupler, power collecting coupler or probe. Further, a member configured by integrating the back short 3 and the semiconductor chip 4 by the rein 7 is referred to sometimes as integrated body. Further, a portion of the package unit 6 opposed to an end face (terminal) of the waveguide 1, namely, the multilayer dielectric substrate 9 including the back face conductor layer 9A that functions as the back short 3 and the front face conductor layer 9B that functions as the antenna coupler 5, is referred to sometimes as conversion unit, signal conversion unit, waveguide-antenna coupler/redistribution line converter or probe coupling type converter. Further, the high frequency module has also a function as a waveguide-antenna coupler/redistribution line converter or a probe coupling type converter. Therefore, the high frequency module is referred to sometimes as signal conversion module.

It is to be noted that, while, in the embodiment described above, the back short 3 and the antenna coupler 5 are configured as the back face conductor layer 9A provided on the back face of the multilayer dielectric substrate 9 and the front face conductor layer 9B provided on the front face at the opposite side to the back face of the multilayer dielectric substrate 9, respectively, and the multilayer dielectric substrate 9 and the semiconductor chip 4 are integrated by the resin 7, the configuration is not limited to this.

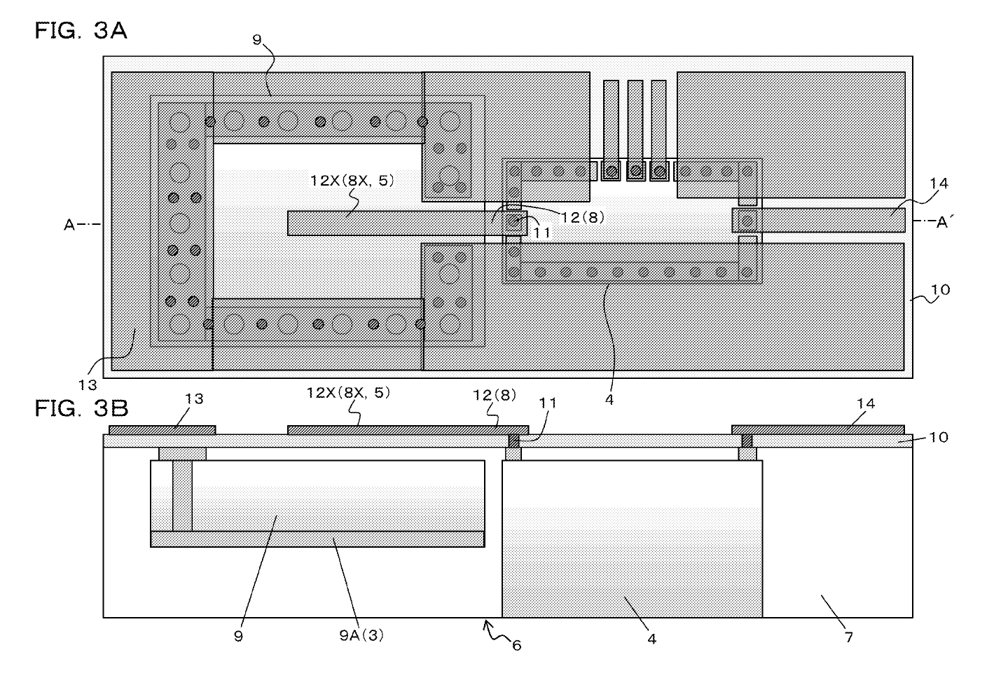

For example, as depicted in FIGS. 3A and 3B, the back short 3 and the antenna coupler 5 may be configured as the conductor layer 9A provided on the back face of the multilayer dielectric substrate 9 and a portion 8X of the redistribution line 8 extending to a region between the waveguide 1 and the back short 3, respectively, and the multilayer dielectric substrate 9 and the semiconductor chip 4 may be integrated by the resin 7. It is to be noted that the configuration just described is referred to as first modification. In this case, the antenna coupler 5 is configured from the portion 8X of the redistribution line 8. In other words, the portion 8X of the redistribution line 8 functions as the antenna coupler 5.

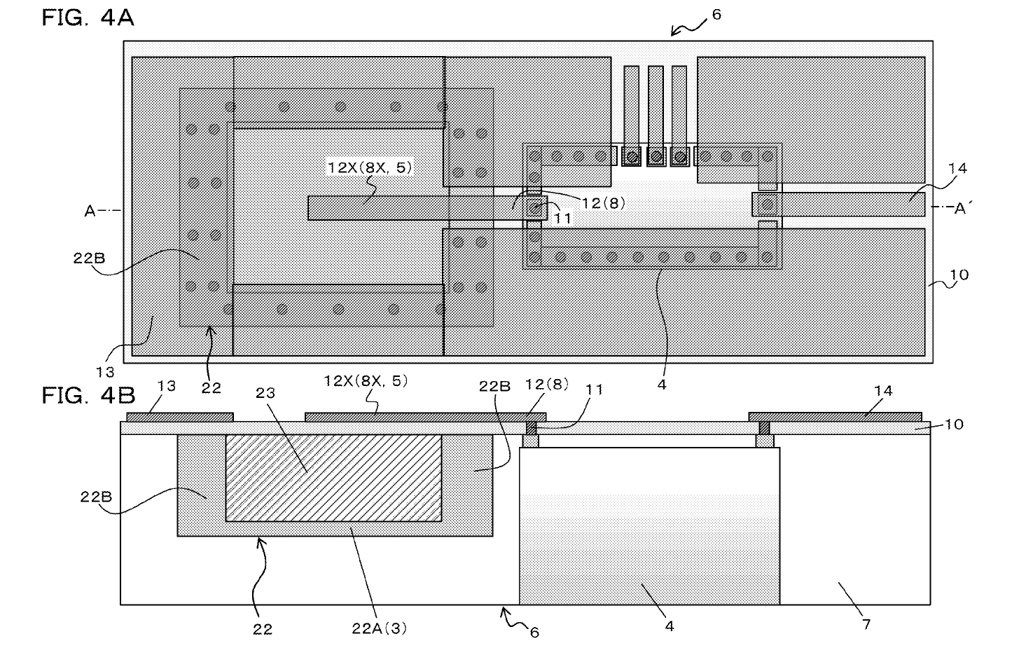

Or, for example, as depicted in FIGS. 4A and 4B, the back short 3 and the antenna coupler 5 may be configured as a bottom portion 22A of a bathtub-shaped metal member 22 having a bottom portion 22A and a frame-shaped side portion 22B and a portion 8X of the redistribution line 8 extending to the region between the waveguide 1 and the back short 3, respectively, and the bathtub-shaped metal member 22 and the semiconductor chip 4 may be integrated by the resin 7. Further, a region (inside) defined by the bottom portion 22A and the frame-shaped side portion 22B of the bathtub-shaped metal member 22 may be buried with dielectric 23. Here, as the dielectric 23, a dielectric having a low dielectric constant or a dielectric having low loss may be used. For example, a material selected from a group of benzocyclobutene, liquid crystal polymer, cycloolefin polymer, polyolefin, polyphenylene ether, polystyrene and fluororesin represented by polytetrafluoroethylene (PTFE) maybe used. It is to be noted that the configuration just described is referred to as second modification. In this case, the antenna coupler 5 is configured from the portion 8X of the redistribution line 8. In other words, the portion 8X of the redistribution line 8 functions as the antenna coupler 5. It is to be noted that the bathtub-shaped metal member 22 is referred to sometimes as bathtub-structured (bathtub-shaped) metal block or metal bathtub structure. Further, the dielectric 23 is referred to sometimes as dielectric block. Further, a member configured by burying the dielectric 23 in the bathtub-shaped metal member 22 is referred to sometimes as back short block (passive element).

In the case of the first modification and the second modification described above, the redistribution line 8 may be configured from a line conductor 12 electrically coupled with the semiconductor chip 4 through the via 11 provided on the resin layer 10 formed on the resin 7 similarly as in the embodiment described above. In this case, a portion 12X of the line conductor 12 extending to the region between the waveguide 1 and the back short 3 functions as the antenna coupler 5. In other words, the portion 12X of the line conductor 12 functions as the antenna coupler 5. The redistribution line 8 having such a configuration as described above may be provided by metal plating using, for example, the semi-additive method or may be provided by metal paste (for example, copper paste or silver paste) using the inkjet method. However, if the cost and the mounting accuracy are taken into consideration, then it is preferable to provide the redistribution line 8 by metal plating using the semi-additive method.

It is to be noted that, while, in the embodiment, first modification and second modification described above, the redistribution line 8 is configured from the line conductor 12 electrically coupled with the semiconductor chip 4 through the via 11 provided on the resin layer 10 formed on the resin 7, the redistribution line is not limited to this. For example, as in a second embodiment and a third embodiment hereinafter described, the redistribution line may be configured from a line conductor electrically coupled with the semiconductor chip through a via formed on a dielectric film provided on resin. The redistribution line having such a configuration as just described maybe provided, for example, by providing a dielectric film having a conductor layer (for example, a metal layer such as a copper foil) on resin of an integrated body and forming a line conductor by patterning a conductor layer and then forming a via on the dielectric film. For example, the redistribution line may be provided by patterning, after a dielectric film on which a metal layer is adhered through an adhesive layer is laminated (bonded) on resin of an integrated body, patterning the metal layer and forming a via on the dielectric film. It is to be noted that whichever one of patterning of the conductor layer and forming of the via may be performed earlier.

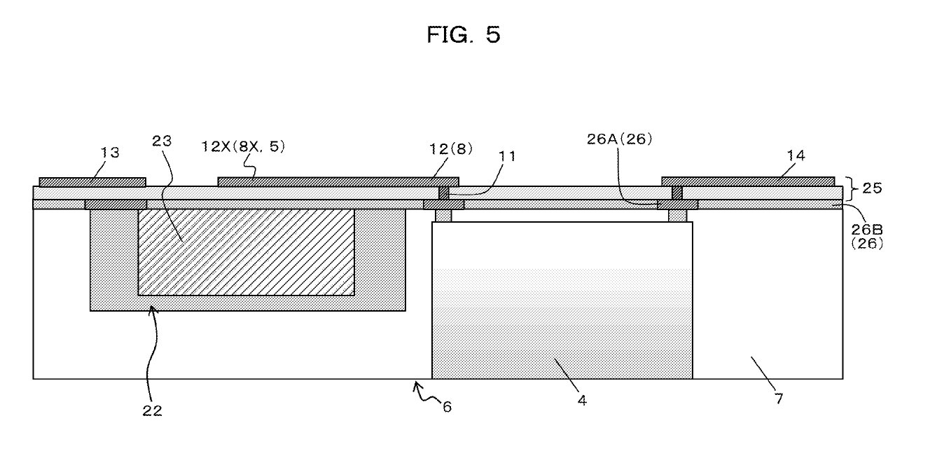

Further, the redistribution line may be provided by attaching a dielectric film on which the redistribution line is patterned to resin of an integrated body. For example, as depicted in FIG. 5, the redistribution line 8 (here, including also the portion 8X that functions as the antenna coupler 5) may be provided by providing a dielectric film 25 having the via 11 and the line conductor 12 (here, including also the portion 12X that functions as the antenna coupler 5) coupled with the via 11 on the resin 7 of the integrated body. For example, the dielectric film 25 on which the line conductor 12 and the via 11 as the redistribution line 8 are patterned may be adhered to the resin 7 of the integrated body by adhesive 26. In this case, it is preferable to use conductive adhesive 26A in order to adhere the via 11 and a region in the proximity of the via 11 patterned on the dielectric film 25 and use low dielectric/low loss adhesive 26B in order to adhere the other regions than the regions just described. It is to be noted that, while the configuration of the second modification is taken as an example in FIG. 5, the forgoing similarly applies also to the embodiment and the first modification described above. However, if the cost and the accuracy of mounting are taken into consideration, then it is preferable to provide the redistribution line by a method of patterning the redistribution line after the dielectric film is attached to the resin of the integrated body described above.

Now, a fabrication method for the high frequency module according to the present embodiment is described.

First, the package unit 6 including the back short 3, semiconductor chip 4 and antenna coupler 5 is fabricated (step of fabricating the package unit).

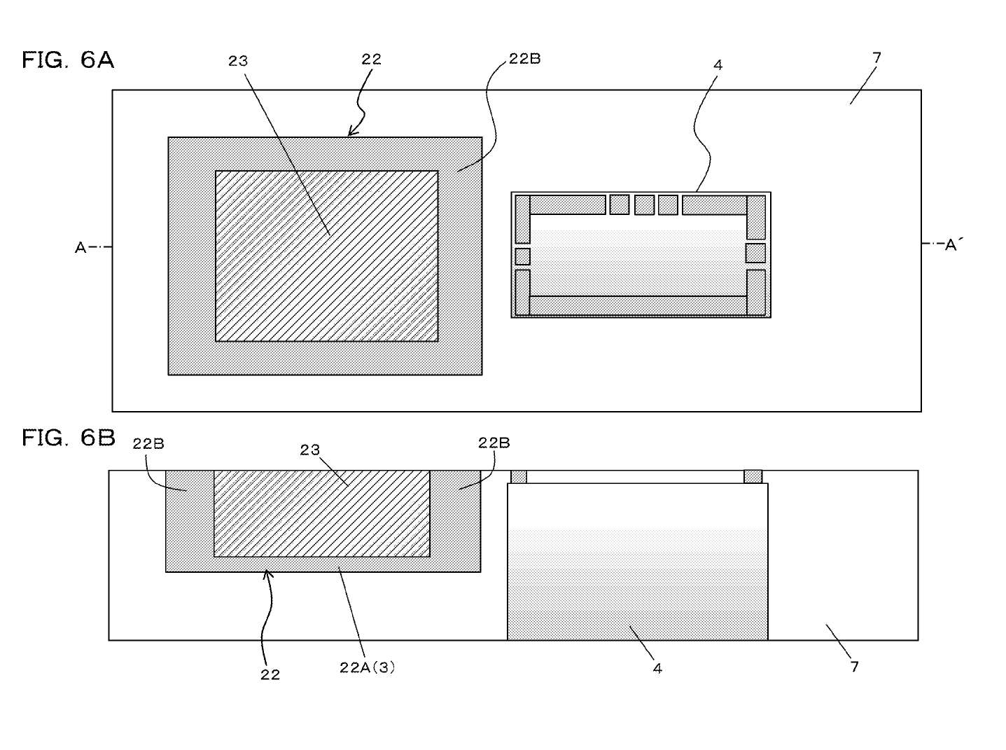

In particular, the back short 3 and the semiconductor chip 4 are integrated first by the resin 7 [refer to FIGS. 6A and 6B]. Then, the redistribution line 8 is provided such that the antenna coupler 5 and the semiconductor chip 4 are electrically coupled with each other.

Here, where the package unit 6 including the configuration of the embodiment described above is fabricated, in the step of integrating by the resin 7, the multilayer dielectric substrate 9 having the back face conductor layer 9A that functions as the back short 3 on the back face and the front face conductor layer 9B that functions as the antenna coupler 5 on the front face opposite side to the back face and the semiconductor chip 4 are integrated by the resin 7.

Further, where the package unit 6 including the configuration of the first modification described above is fabricated, in the step of integrating by the resin 7, the multilayer dielectric substrate 9 having the conductor layer 9A that functions as the back short 3 on the back face and the semiconductor chip 4 are integrated by resin and, in the step of providing the redistribution line 8, the redistribution line 8 is provided so as to extend to a region over the back short 3 such that it includes the portion 8X that functions as the antenna coupler 5.

On the other hand, where the package unit 6 including the configuration of the second modification described above is fabricated, in the step of integrating by the resin 7, the bathtub-shaped metal member 22 having the bottom portion 22A that functions as the back short 3 and the frame-shaped side portion 22B and the semiconductor chip 4 are integrated by resin and, in the step of providing the redistribution line 8, the redistribution line 8 is provided so as to extend to a region over the back short 3 such that it includes the portion 8X that functions as the antenna coupler 5.

Where the package unit 6 is fabricated in such a manner as described, the step of providing the redistribution line 8 may include a step of forming the resin layer 10 on the resin 7, a step of forming the via 11 on the resin layer 10 and a step of forming the line conductor 12 on the resin layer 10. For example, a step at which the semi-additive method is used or a step at which the inkjet method is used is included as the step just described. Further, the step of providing the redistribution line 8 may include a step of providing a dielectric film having a conductor layer on the resin 7, a step of forming a via on the dielectric film and a step of forming a line conductor by patterning the conductor layer. For example, a step of patterning the redistribution line after the dielectric film having the conductor layer is attached to the resin of the integrated body is included as the step just described. It is to be noted that whichever one of the step of forming the via and the step of forming the line conductor may be performed earlier. Further, in the step of providing the redistribution line, the dielectric film having the via and the line conductor coupled with the via maybe provided on the resin. For example, a step of attaching the dielectric film on which the redistribution line is patterned on the resin of the integrated body is included as the step just described.

Then, the package unit 6 fabricated in such a manner as described above is attached to the metal housing 2 having the waveguide 1 such that the back short 3 is positioned on an extension of the waveguide 1 and besides the antenna coupler 5 is positioned between the waveguide 1 and the back short 3.

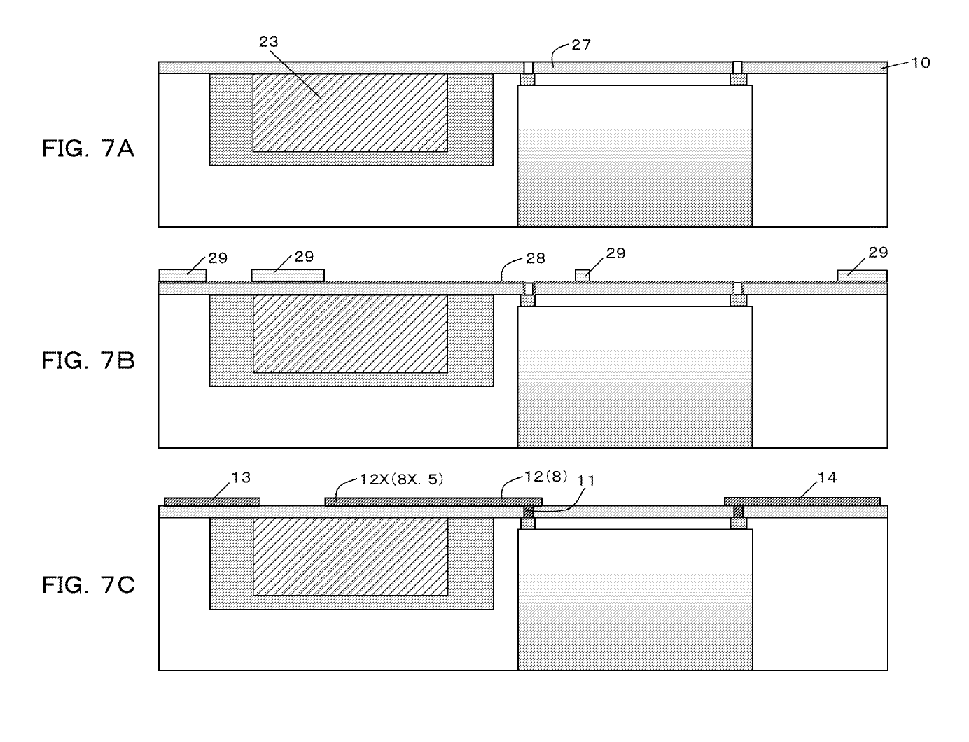

In the following, the fabricate method of the high frequency module according to the present embodiment is further described with reference to FIGS. 6A, 6B and 7A to 7C taking a case in which the redistribution line 8 is formed on the high frequency module having the configuration of the second modification described above by metal plating using the semi-additive method as an example.

First, as depicted in FIGS. 6A and 6B, the back short 3 and the semiconductor chip 4 are integrated by the resin 7.

In particular, the bathtub-shaped metal member 22 that has the bottom portion 22A that functions as the back short 3 and the frame-shaped side portion 22B and in which a region defined by the bottom portion 22A and the frame-shaped side portion 22B is buried with the dielectric 23 and the semiconductor chip 4 are buried with the mold resin 7 and integrated by the mold resin 7. Consequently, an integrated body (pseudo wafer) molded by resin composition is produced.

Then, as depicted in FIGS. 7A to 7C, the redistribution line 8 is provided such that the antenna coupler 5 and the semiconductor chip 4 are electrically coupled with each other. Here, the redistribution line 8 is provided so as to extend to a region over the back short 3 (bottom portion 22A of the bathtub-shaped metal member 22) such that it includes the portion 8X that functions as the antenna coupler 5.

In particular, as depicted in FIG. 7A, photosensitive resin is applied first to the integrated body produced in such a manner as described above to form the photosensitive resin layer 10, and the photosensitive resin layer 10 is patterned to form a via hole 27.

Then, as depicted in FIG. 7B, a seed layer 28 formed, for example, from copper or copper alloy is formed, for example, by sputtering or electroless plating and resist 29 is patterned. It is to be noted that, in order to enhance the adhesion property between the photosensitive resin layer 10 and the seed layer 28, a contact adhesive layer formed, for example, from Ti, Cr, W or alloy of them may be formed.

Then, as depicted in FIG. 7C, by plating copper, for example, by electroplating using the seed layer 28, the via 11 is formed on the via hole 27 and the line conductor 12 (here, including also the line conductor portion 12X as the redistribution line portion 8X that functions as the antenna coupler 5) as the redistribution line 8 is formed on the photosensitive resin layer 10. It is to be noted that, at this step, also a different via, a redistribution ground portion and a redistribution signal line are formed. Then, after the resist 29 (photoresist) is detached, the seed layer 28 remaining under the resist 29 is removed for example, by wet etching or dry etching.

In this manner, the redistribution line 8 configured from the copper line 12 (metal line; line conductor) electrically coupled with the semiconductor chip 4 through the via provided on the photosensitive resin layer 10 formed on the mold rein 7 is formed. Further, the redistribution line 8 is formed so as to extend to the region over the back short 3 and include the portion 8X that functions as the antenna coupler 5.

Accordingly, with the high frequency module and the fabrication method for the high frequency module according to the present embodiment, there is an advantage that degradation of a high frequency characteristic when a high frequency signal is transmitted between the waveguide 1 and the semiconductor chip 4 can be reduced.

### Second Embodiment

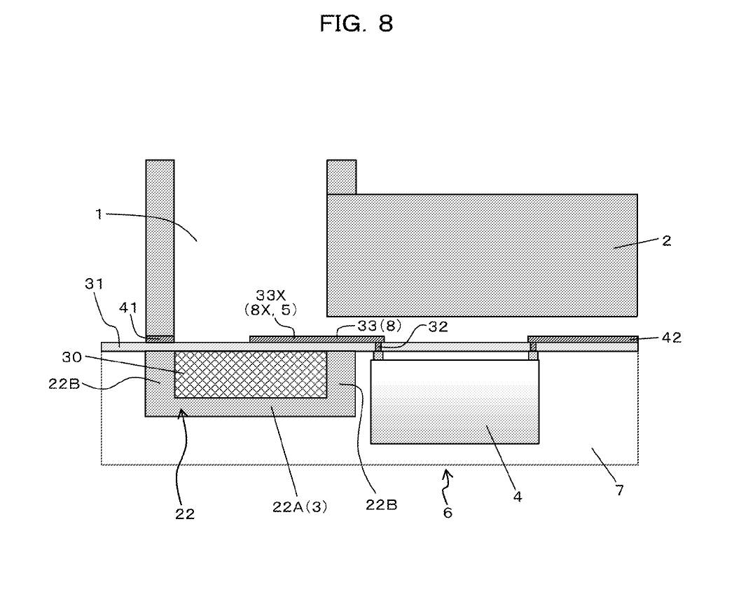

First, a high frequency module and a fabrication method for the high frequency module according to a second embodiment are described with reference to FIGS. 8 to 12B.

The high frequency module according to the present embodiment is different from that of the second modification to the first embodiment described above in that, as depicted in FIG. 8, a region 30 defined by the bottom portion 22A and frame-shaped side portion 22B of the bathtub-shaped metal member 22 is a space [indicated by hatching lines in FIG. 8]. In particular, in the present embodiment, a dielectric is not buried in the region 30 defined by the bottom portion 22A and the frame-shaped side portion 22B of the bathtub-shaped metal member 22 and the region 30 is configured as a space, and an upper opening of the region 30 is covered with and closed up by a dielectric film 31 for forming the redistribution line 8 (including the portion 8X that functions as the antenna coupler 5). In this manner, a hollow structure is formed by covering the opening of the bathtub-shaped metal member 22 with the dielectric film 31. In other words, the bathtub-shaped metal member 22 has a hollow structure. By forming the region 30 defined by the bottom portion 22A and the frame-shaped side portion 22B of the bathtub-shaped metal member 22 as a space such that air having a low dielectric constant exists in the region 30 in this manner, reduction of a high frequency gain can be suppressed and reduction of loss can be achieved. It is to be noted that the dielectric film 31 is referred to sometimes as insulating film, resin film or insulating resin film. Further, in FIG. 8, reference numerals 41 and 42 denote a redistribution ground portion and a redistribution signal line, respectively.

Therefore, the redistribution line 8 is configured from a line conductor 33 (including a portion 33X that functions as the antenna coupler 5) electrically coupled with the semiconductor chip 4 through the via 32 formed on the dielectric film 31 provided on the resin 7.

Also in this case, similarly as in the case of the second modification to the first embodiment described above, the back short 3 is the bottom portion 22A of the bathtub-shaped metal member 22 having the bottom portion 22A and the frame-shaped side portion 22B and the antenna coupler 5 is the portion 8X of the redistribution line 8 extending to the region between the waveguide 1 and the back short 3, and the bathtub-shaped metal member 22 and the semiconductor chip 4 are integrated by the resin 7. In this case, depending upon the depth of the region 30 defined by the bottom portion 22A and the frame-shaped side portion 22B of the bathtub-shaped metal member 22 and the thickness of the dielectric film 31, the distance between the antenna coupler 5 and the back short 3 is set with high accuracy to ¼ the wavelength A of a high frequency signal to be transmitted.

The redistribution line 8 having such a configuration as described above (including the portion 8X that functions as the antenna coupler 5) may be provided, for example, by providing the dielectric film 31 having a conductor layer 33A (for example, a metal layer such as copper foil) on the resin 7 of the integrated body and patterning the conductor layer 33A to form the line conductor 33 (including the portion 33X that functions as the antenna coupler 5) and then forming the via 32 on the dielectric film 31.

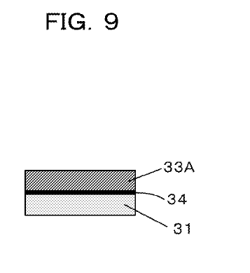

In the present embodiment, the redistribution line 8 (including the portion 8X that functions as the antenna coupler 5) is provided by patterning, after the dielectric film 31 (refer to FIG. 9) to which the metal layer 33A is adhered through the adhesive layer 34 is laminated (bonded) on the resin 7 of the integrated body, the metal layer 33A to form the line conductor 33 (including the portion 33X that functions as the antenna coupler 5) and forming the via 32 on the dielectric film 31. Since the front face of the dielectric film 31 can be prevented from being roughed by using the adhesive layer 34 in this manner, the loss in a high frequency band such as, for example, a millimeter wave or a terahertz wave can be reduced low.

Preferably, the dielectric film 31 here is configured from a dielectric having a low dielectric constant (low dielectric constant material) or a dielectric that exhibits low loss (low loss material). In particular, the dielectric film 31 is preferably configured from a material selected, for example, from a group of benzocyclobutene, liquid crystal polymer, cycloolefin polymer, polyolefin, polyphenylene ether, polystyrene and fluororesin represented by polytetrafluoroethylene (PTFE). It is to be noted that the dielectric film 31 configured from such a low dielectric constant material as just described is referred to sometimes as low dielectric material film. Further, where use in a high frequency band such as a millimeter wave or terahertz wave is assumed, preferably the surface roughness of the dielectric film 31 is approximately 0.3 micron or less in ten point average roughness.

For example, copper or copper alloy can be used for the metal layer 33A. Further, metal foil may be used for the metal layer 33A. It is to be noted that the metal layer 33A maybe formed, for example, by sputtering, electroless plating, electric plating or the like.

For the adhesive layer 34, a material such as a compound containing a nitro group, a carboxy group or a cyano group (nitrobenzoic acid, cyanobenzoic acid or the like) can be used. Also a silane coupling agent containing a mercapto group or an amino group, triazine thiol configured from a mercapto group or the like can be used.

In this manner, the low dielectric material film 31 to which the metal layer 33A is adhered through the adhesive layer 34 can be formed, for example, by forming an adhesive layer on the front face of metal foil (for example, copper foil) and then coating a low dielectric constant material (resin) on the adhesive layer. The low dielectric material film can be formed, for example, by stacking copper foil (for example, of a thickness of 9 μm), an adhesive layer and a film (for example, of a thickness of 10 μm) configured from a low dielectric constant material. Also it is possible to form the metal layer (for example, a copper layer) by sputtering or electroless plating on an adhesive layer formed on a low dielectric constant material after the low dielectric constant material is coated on a supporting film.

Now, a fabrication method for the high frequency module according to the present embodiment is described.

First, the package unit 6 including the back short 3, semiconductor chip 4 and antenna coupler 5 is fabricated (step of fabricating a package unit).

In particular, the back short 3 and the semiconductor chip 4 are integrated by the resin 7 first. Then, the redistribution line 8 is provided such that the antenna coupler 5 and the semiconductor chip 4 are electrically coupled with each other.

Here, where the package unit 6 having the configuration of the embodiment described above is to be fabricated, in the step of integrating by the resin 7, the bathtub-shaped metal member 22 having the bottom portion 22A that functions as the back short 3 and the frame-shaped side portion 22B and the semiconductor chip 4 are integrated by the resin 7 and, in the step of providing the redistribution line 8, the redistribution line 8 is provided so as to extend to a region over the back short 3 and include the portion 8X that functions as the antenna coupler 5.

Where the package unit 22 is fabricated in such a manner as described above, the step of providing the redistribution line 8 includes a step of providing the dielectric film 31 including the conductor layer 33A on the resin 7, another step of forming the via 32 on the dielectric film 31 and a further step of patterning the conductor layer 33A to form the line conductor 33. For example, a step of patterning the redistribution line 8 after the dielectric film 31 having the conductor layer 33A is attached to the resin 7 of the integrated body is included as the step just described. It is to be noted that whichever one of the step of forming the via 32 and the step of forming the line conductor 33 may be performed earlier.

Then, the package unit 6 fabricated in such a manner as described above is attached to the metal housing 2 having the waveguide 1 such that the back short 3 is positioned on an extension of the waveguide 1 and the antenna coupler 5 is positioned between the waveguide 1 and the back short 3.

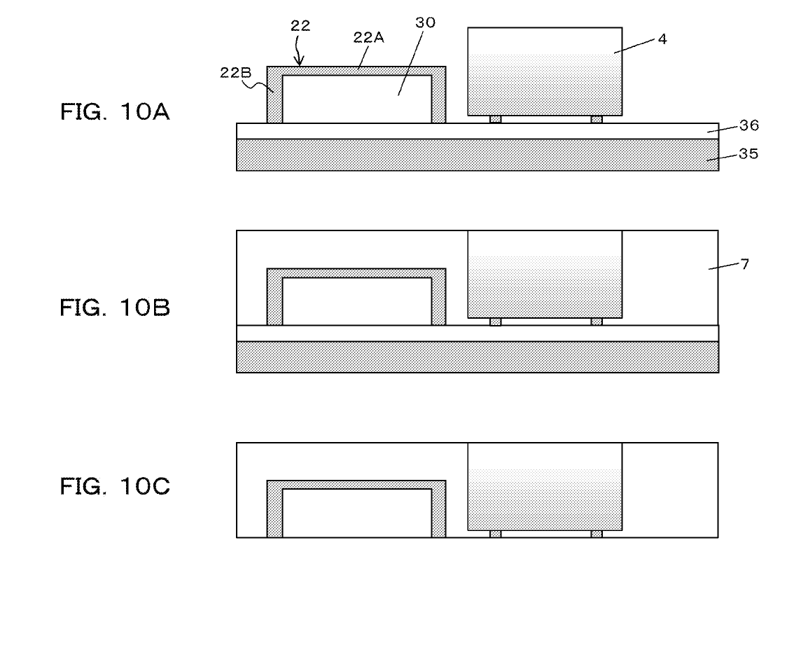

In the following, description is given with reference to FIGS. 10A to 12B taking a case in which the redistribution line 8 is provided by patterning, after the dielectric film 31 to which the metal layer 33A is adhered through the adhesive layer 34 is laminated (bonded) on the resin 7 of the integrated body, the metal layer 33A and forming the via 32 on the dielectric film 31 as an example.

First, the back short 3 and the semiconductor chip 4 are integrated by the resin 7 as depicted in FIGS. 10A to 10C.

In particular, as depicted in FIG. 10A, the bathtub-shaped metal member 22 which has the bottom portion 22A that functions as the back short 3 and the frame-shaped side portion 22B and in which the region 30 defined by the bottom portion 22A and the frame-shaped side portion 22B forms a space, and the semiconductor chip 4 are disposed on a pressure-sensitive adhesive face of a pressure-sensitive adhesive film 36 provided on a supporting body 35. In particular, the bathtub-shaped metal member 22 and the semiconductor chip 4 are temporarily fixed to a desired position of the pressure-sensitive adhesive film 36 provided on the supporting body 35 in a facedown posture in which the opening of the bathtub-shaped metal member 22 and the circuit face of the semiconductor chip 4 are directed downwardly. This is because that it is intended to prevent, when the bathtub-shaped metal member 22 and the semiconductor chip 4 are buried with the mold resin 7, the region 30 (space) defined by the bottom portion 22A and the frame-shaped side portion 22B of the bathtub-shaped metal member 22 from being buried with the mold resin 7.

Here, for the supporting body 35, for example, a Si substrate (Si wafer), a glass substrate, a metal plate such as an aluminum plate, a stainless plate or a copper plate, a polyimide film, a printed board or the like can be used. It is to be noted that the supporting body 35 is referred to sometimes as supporting substrate.

Meanwhile, for the pressure-sensitive adhesive film 36, a member wherein a pressure-sensitive adhesive is provided on abase material having high heat resistance such as polyimide resin, silicone resin or fluororesin can be used. It is to be noted that the pressure-sensitive adhesive film 36 may be attached to the supporting body 35 and, for example, the pressure-sensitive adhesive film 36 may be attached to the supporting body 35 by a pressure-sensitive adhesive provided at a reverse face side of the base material of the pressure-sensitive adhesive film 36. Further, the pressure-sensitive adhesive film 36 may have a one-layer structure or may have a multilayer structure of two layers or more. Further, a member wherein a pressure-sensitive adhesive is provided directly on the supporting body 35 can be used without using the pressure-sensitive adhesive film 36. Further, as a material for the pressure-sensitive adhesive, for example, epoxy resin, acrylic resin, polyimide resin, silicone resin, urethane resin or the like can be used.

Further, for the pressure-sensitive adhesive film 36, it is required as a characteristic that the pressure-sensitive adherence does not degrade by heating upon molding and that, after a molded compact (integrated body; pseudo wafer) is formed by molding, the molded compact can be detached readily without degrading the pressure-sensitive adherence. To this end, preferably the pressure-sensitive adhesive film 36 has formed thereon, for example, a shape like a projection having a cavity like a crater open on the surface thereof in order that, in the horizontal direction, the pressure-sensitive adhesive film 36 has a strength sufficient to prevent displacement of the semiconductor chip 4 or the bathtub-shaped metal member 22 and, in the vertical direction, peeling of the pressure-sensitive adhesive film 36 is facilitated.

Further, as a method for disposing the bathtub-shaped metal member 22 or the semiconductor chip 4 on the pressure-sensitive adhesive film 36, for example, a flip chip bonder, a mounter or the like can be used.

Then, the bathtub-shaped metal member 22 and the semiconductor chip 4 are buried with the resin 7 and integrated by the resin 7 as depicted in FIG. 10B.

Here, as the mold resin 7, an epoxy-based resin, a cycloolefin-based rein, an acrylic-based resin, a polyimide-based resin and so forth can be used. Further, in the mold resin, for example, alumina, silica, aluminum nitride, aluminum hydroxide or the like may be contained as an inorganic filler as occasion demands.

Then, the supporting body 35 and the pressure-sensitive adhesive film 36 are detached from each other as depicted in FIG. 10C.

An integrated body (pseudo wafer) molded from a resin compound is produced in this manner.

Here, the shape of the integrated body in which the bathtub-shaped metal member 22 and the semiconductor chip 4 are integrated, namely, of an electronic part restructured by the integration of them, may be a circular shape like that of a wafer or a quadrangular shape. For example, if the integrated body has a circular shape like that of a wafer, then it is possible to use a semiconductor fabrication equipment when the redistribution line 8 is formed. However, if the integrated boy has a quadrangular shape, then it is possible to use printed wiring board fabrication equipment when the redistribution line 8 is formed.

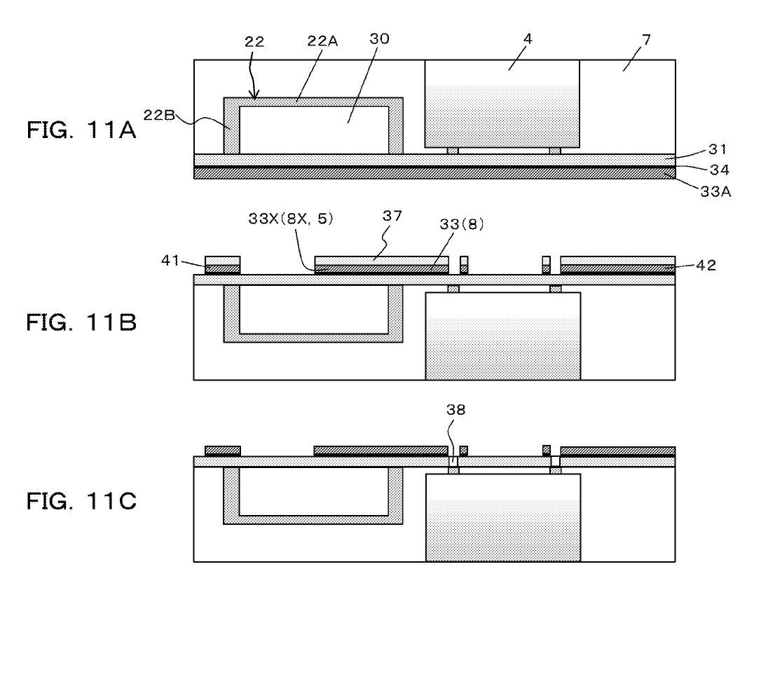

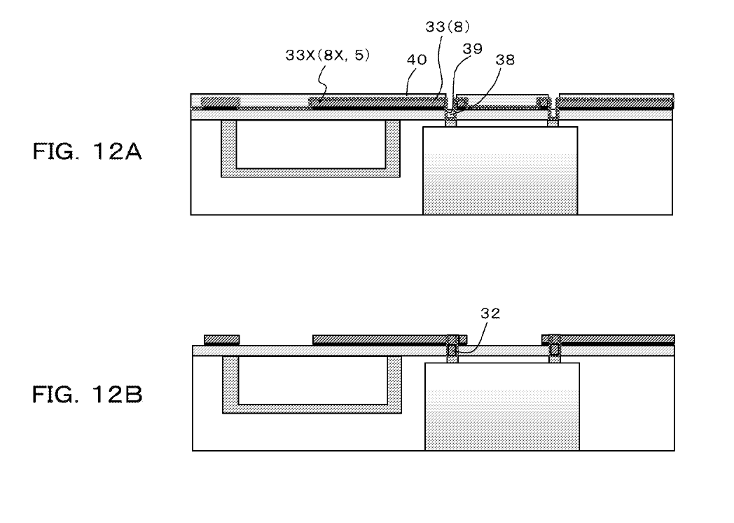

Then, the redistribution line 8 is provided such that the antenna coupler 5 and the semiconductor chip 4 are electrically coupled with each other as depicted in FIGS. 11A to 11C, 12A and 12B. Here, the redistribution line 8 is provided so as to extend to a region over the back short 3 and include the portion 8X that functions as the antenna coupler 5.

In particular, as depicted in FIG. 11A, the integrated body fabricated in such a manner as described above is first laminated on the dielectric film 31 (for example, of a liquid crystal polymer) to which the metal layer 33A (for example, copper foil) is adhered through the adhesive layer 34. In other words, the dielectric film 31 to which the metal layer 33A is adhered through the adhesive layer 34 is bonded to the integrated body fabricated in such a manner as described above, for example, while the dielectric film 31 is heated and pressed.

Then, patterning is performed using, for example, a dry film resist 37 (or liquid resist) as depicted in FIG. 11B.

For example, the dry film resist 37 made of an acrylic-based material is formed by lamination and exposure is performed by a contact aligner or a g-line or i-line stepper and then development is performed, for example, with sodium carbonate. Consequently, the antenna coupler portion, line portion of the semiconductor chip 4, ground portion over the back short 3 and so forth are patterned.

On the other hand, where liquid resist is used, photosensitive phenolic resin is applied by spin coating so as to have, for example, a thickness of 2 μm and exposure is performed by a contact aligner or a g-line or i-line stepper and then development is performed, for example, by tetramethylammonium hydroxide (TMAH). Consequently, the antenna coupler portion, line portion of the semiconductor chip 4, ground portion over the back short 3 and so forth are patterned.

Then, the metal layer 33A is etched. For example, using a resist pattern as a mask, wet etching is performed for the copper foil 33A adhered to the dielectric film 31 using mixture liquid of sulfuric acid and hydrogen peroxide solution, potassium sulfate or the like as etching liquid. Consequently, the copper foil 33A provided over the bathtub-shaped metal member 22 and terminals of the semiconductor chip 4 is removed.

Then, the via hole 38 is formed on the dielectric film 31 as depicted in FIG. 11C using, for example, a laser or the like. For example, a carbon dioxide laser, a UV-YAG laser so forth can be used for formation of the via hole 38.

Then, after the dry film resist 37 is detached, a seed layer 39 made of, for example, copper or copper alloy is formed, for example, by sputtering or electroless plating to pattern the resist 40 as depicted in FIG. 12A.

Here, where the seed layer 39 is formed by sputtering, in order to enhance the adhesion performance to a ground for the seed layer 39, for example, a titanium (Ti) layer may be provided as a contact adhesive layer. In this case, the Ti layer maybe formed, for example, by sputtering so as to have a thickness of approximately 100 nm and a Cu (copper) layer may be formed on the Ti layer by sputtering so as to have a thickness of approximately 100 nm.

Further, for example, where liquid resist is used, patterning of the resist 40 may be performed by performing, after the resist is applied, exposure by a contact aligner, a g-line or i-line stepper or the like and performing development using alkali development liquid to remove the resist 40 existing over the bathtub-shaped metal member 22 and terminals of the semiconductor chip 4.

Then, the via 32 is formed on the via hole 38 by plating copper, for example, by electric metal plating using the seed layer 39 and the resist 40 (photoresist) is removed, and then the seed layer 39 remaining under the resist 40 is removed by wet etching or dry etching as depicted in FIG. 12B.

For example, Cu is deposited as a conductive material by electrolytic metal plating using the seed layer as a power feeding layer to form a via in each opening of the resist pattern. The metal plating height of each via is set, for example, to 10 μm. By each via, the pattern formed from copper foil, the bathtub-shaped metal member 22 and the terminals of the semiconductor chip 4 are electrically coupled with each other. It is to be noted that the metal plating height of the via can be suitably selected in response accordance with the design.

Further, for example, where liquid resist is used, the resist pattern may be removed using solvent of acetone or the like. Where dry film resist is used, the resist pattern may be removed using sodium hydroxide or organic amine-based aqueous solution.

Further, where the seed layer is formed from a Cu layer, the resist pattern may be removed, for example, by wet etching using mixture liquid of sulfuric acid and hydrogen peroxide solution, potassium sulfate or the like as etching liquid. Further, where a Ti layer is provided as a contact adhesive layer under the seed layer, the Ti layer may be removed by wet etching using, for example, calcium ammonium aqueous solution as etching solution or by dry etching using, for example, mixture gas of CF₄ and O₂.

The redistribution line 8 configured from the copper line 33 (metal line; line conductor) electrically coupled with the semiconductor chip 4 through the via 32 formed on the dielectric film 31 provided on the mold resin 7 is provided in this manner. Further, the redistribution line 8 is formed so as extend to the region over the back short 3 and include the portion 8X that functions as the antenna coupler 5.

In particular, a pressure-sensitive adhesive layer having a thickness of approximately 50 μm and including silicone resin as a main component is formed on an SUS carrier as the supporting body 35. It is to be noted that preferably the pressure-sensitive adhesive layer has a shape formed like a projection having a cavity of a diameter of approximate 2 μm and a height of approximately 0.3 μm like a crater open on the surface thereof by a nano imprinting method. Then, the polyimide film (pressure-sensitive adhesive film) 36 of a thickness of approximately 50 μm on the front face of which silicone-based pressure-sensitive adhesive is provided as a pressure-sensitive adhesive is disposed on the pressure-sensitive adhesive layer such that the silicone-based pressure-sensitive adhesive side is placed at the opposite side to the pressure-sensitive adhesive layer. Thereafter, the bathtub-shaped metal member 22 made of copper and the semiconductor chip 4 are disposed on the silicone-based pressure-sensitive adhesive as a pressure-sensitive adhesive using a flip chip bonder such that the opening of the bathtub-shaped metal member 22 made of copper and the circuit face of the semiconductor chip 4 are placed at the silicone-based pressure-sensitive adhesive side. Then, the bathtub-shaped metal member 22 made of copper and the semiconductor chip 4 are buried with the mold resin 7 and integrated by the mold resin 7 using a metal mold. Thereafter, the pressure-sensitive adhesive film 36 is detached and the mold resin 7 is fully hardened at a temperature of approximately 150° C. for approximately one hour. The integrated body (pseudo wafer) wherein the copper bathtub-shaped metal member 22 and the semiconductor chip 4 are integrated by the mold resin 7 is fabricated in this manner.

Then, triazinethiol is formed as the adhesive layer 34 on the copper foil 33A having a thickness of approximately 18 μm. Further, the integrated body is laminated at the benzocyclobutene side of the dielectric film 31 (resin sheet) with the copper foil on which benzocyclobutene is deposited as a low dielectric constant material. Then, by performing exposure and development using the dry film resist 37, a line pattern of approximately 20 μm and a via hole pattern of approximately 30 μm are formed. Then, the copper foil 33A is etched using mixture liquid of sulfuric acid and hydrogen peroxide. Then, the via hole 38 of approximately 20 μm is formed using a UV-YAG laser. Then, after the dry film resist 37 is detached, titanium and copper are deposited by sputtering so as to have thicknesses of 0.1 μm and 0.3 μm, respectively, to form the seed layer 39. Thereafter, the photoresist pattern in which openings of the via portion and the line portion are formed is formed, and plating of copper is performed by electric metal plating using the seed layer 39 formed earlier. Then, after the photoresist 40 is detached, the seed layer 39 remaining under the photoresist 40 is removed by wet etching and dry etching. The redistribution line 8 is formed in this manner.

It is to be noted that, since particulars of the other part are similar to those of the first embodiment and the modifications described hereinabove, description of them is omitted.

Accordingly, with the high frequency module and the fabrication method for the high frequency module according to the present embodiment, similarly as in the first embodiment and the modifications described hereinabove, there is an advantage that degradation of a high frequency characteristic when a high frequency signal is transmitted between the waveguide tube 1 and the semiconductor chip 4 can be reduced.

It is to be noted that, while, in the embodiment described above, the dielectric film 31 having the conductor layer 33A (for example, a metal layer such as copper foil) is provided on the resin 7 of the integrated body and the line conductor 33 (here, including also the portion 33X that functions as the antenna coupler 5) is formed by patterning the conductor layer 33A and then the redistribution line 8 (here, including also the portion 8X that functions as the antenna coupler 5) is provided by forming the via 32 on the dielectric film 31, the provision of the redistribution line is not limited to this.

For example, the redistribution line may be provided by providing a dielectric film having a via and a line conductor coupled with the via on the resin of the integrated body. This provision includes, for example, a configuration wherein a dielectric film on which the line conductor and the via as the redistribution line are patterned is attached to the resin of the integrated body. In particular, a configuration is included wherein the dielectric film on which the line conductor and the via as the redistribution line are patterned is adhered to the resin of the integrated body using adhesive. In this case, it is preferable to use conductive adhesive in order to adhere the via patterned on the dielectric film and a region in the proximity of the via and use low dielectric and low loss adhesive in order to adhere the other region than the region just described. However, if the cost and the accuracy of mounting are taken into consideration, then it is preferable to provide the redistribution line in such a manner as in the embodiment described hereinabove. In this case, in the step of providing the redistribution line, the dielectric film having the via and the line conductor coupled with the via is provided on the resin.

### Third Embodiment

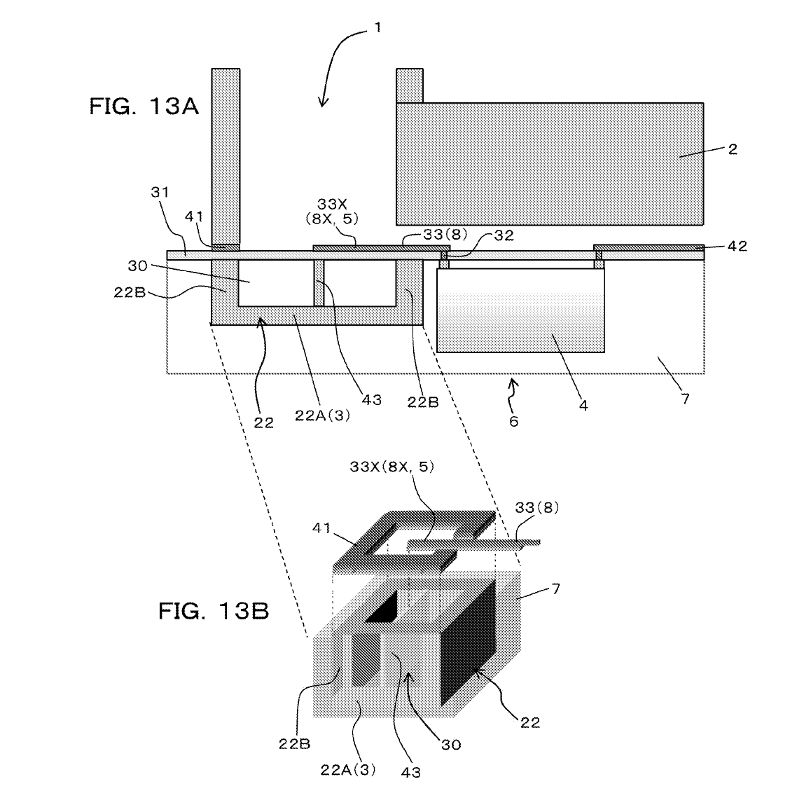

First, a high frequency module and a fabrication method for the high frequency module according to a third embodiment are described with reference FIGS. 13A to 16F.

The high frequency module according to the present embodiment is different from that of the second embodiment described hereinabove in that, as depicted in FIGS. 13A and 13B, the region 30 defined by the bottom portion 22A and the frame-shaped side portion 22B of the bathtub-shaped metal member 22 is formed as a space and a dielectric supporting member 43 that supports the antenna coupler 5 is provided in the region 30. It is to be noted that, in FIGS. 13A and 13B, reference numeral 41 and 42 denote a redistribution ground portion and a redistribution signal line, respectively.

By providing the dielectric supporting member 43 and supporting the antenna coupler 5 on the electric supporting member 43 in this manner, it becomes possible to keep the distance between the back short 3 that is the bottom portion 22A of the bathtub-shaped metal member 22 and the antenna coupler 5 that is the portion 8X of the redistribution line 8 extending to the region between the waveguide tube 1 and the back short 3. In this case, depending upon the depth of the region 30 defined by the bottom portion 22A and the frame-shaped side portion 22B of the bathtub-shaped metal member 22, height of the dielectric supporting member 43 and thickness of the dielectric film 31, the distance between the antenna coupler 5 and the back short 3 can be set and kept with high accuracy to and at ¼ the wavelength λ of a high frequency signal to be transmitted. Especially, it is possible to prevent the position in a vertical direction of a tip end position of the antenna coupler 5 from being varied by the gravity. Consequently, where the region 30 defined by the bottom portion 22A and the frame-shaped side portion 22B of the bathtub-shaped metal member 22 is formed as a space, it is possible to moderate such a situation that the gain or a high frequency characteristic is degraded.

In this case, over the region 30 defined by the bottom portion 22A and the frame-shaped side portion 22B of the bathtub-shaped metal member 22, namely, over the space, the dielectric film 31 in a region other than the portion 8X of the antenna coupler 5 (here, portion 33X of the line conductor 33) configured from the redistribution line 8 (here, line conductor 33) provided on the dielectric film 31 may be removed to establish an opening state. In particular, a state in which only the antenna coupler 5 configured from the redistribution line 8 provided on the dielectric film 31 may project to a region over the region 30 defined by the bottom portion 22A and the frame-shaped side portion 22B of the bathtub-shaped metal member 22, namely, to a region over the space. In this manner, by removing the dielectric film 31, reduction of the high frequency gain can be suppressed further and further reduction of the loss can be achieved. In particular, by providing a requisite minimum dielectric in the region 30 defined by the bottom portion 22A and the frame-shaped side portion 22B of the bathtub-shaped metal member 22, namely, in a region in which the antenna coupler 5 and the back short 3 exist so that air having a low dielectric constant exists almost in the region, further reduction of the high frequency gain can be anticipated and further reduction of the loss can be anticipated.

Here, as a material that can be used for the dielectric supporting member 43, preferably a material having a dielectric tangent as small as possible in a high frequency region is used from the point of view of reduction of the loss. The value of the dielectric tangent (tame) preferably is equal to or lower than 0.002 (1 GHz) and more preferably is equal to or lower than approximately 0.001. Even if the value of the dielectric tangent is higher, if there is no influence on a required frequency characteristic, then the material can be used. However, since the rise of the dielectric tangent in the high frequency region of approximately 100 to approximately 300 GHz is greater than that in approximately 1 GHz, the range specified above is preferable.

Especially, the dielectric supporting member 43 is preferably made of a dielectric of a low dielectric constant (low dielectric constant material) or a dielectric of low loss (low loss material). In particular, the dielectric supporting member 43 is preferably made of a material selected from a group of benzocyclobutene (BCB), liquid crystal polymer (LCP), cycloolefin polymer (COP), polyolefin, polyphenylene ether (PPE), polystyrene and fluororesin represented by polytetrafluoroethylene (PTFE). It is to be noted that the dielectric supporting member 43 made of such a low dielectric constant material as described above is hereinafter referred to sometimes as low dielectric material supporting member.

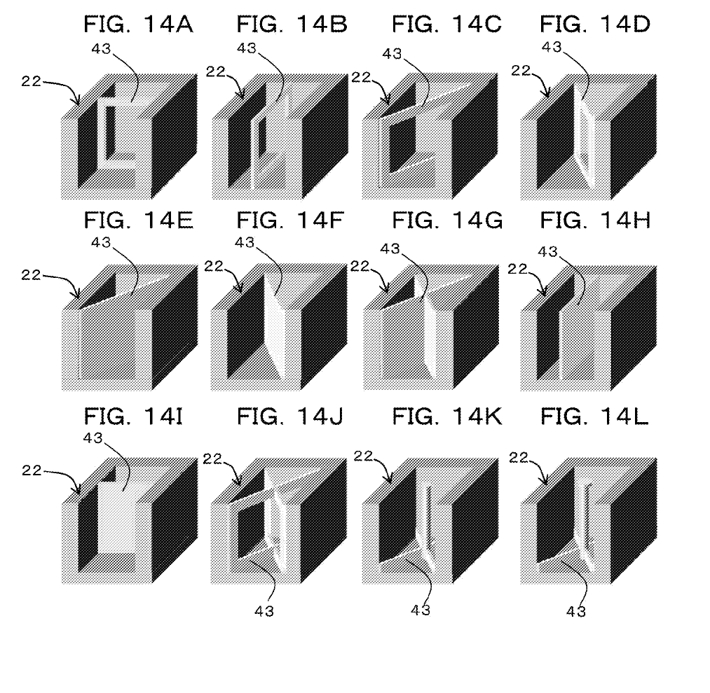

Further, although there is no particular limitation to the shape of the dielectric supporting member 43, the dielectric supporting member 43 preferably has a shape of a plate, a frame or a pillar. More particularly, the dielectric supporting member 43 may have any of such shapes and dispositions as depicted in FIGS. 14A to 14L. It is to be noted that, in FIGS. 14A to 14L, in order to facilitate recognition, the wall at this side of the bathtub-shaped metal member 22 is omitted.

It is to be noted that, although the thickness of the dielectric supporting member 43 is free from limitation only if the dielectric supporting member 43 can support the antenna coupler 5, where the dielectric supporting member 43 is inserted into the region 30 formed as a space in the bathtub-shaped metal member 22, for example, by a chip mounter or a chip bonder, the dielectric supporting member 43 preferably has a thickness sufficient to withstand absorption by a nozzle. For example, although it depends upon the material, the dielectric supporting member 43 preferably has a thickness basically of approximately several tens μm. It is to be noted that, if the thickness of the dielectric supporting member 43 is excessively great, then the proportion of the air in the space (hollow region) of the bathtub-shaped metal member 22 becomes insufficient, which is not preferable in terms of moderation of reduction of the high frequency gain. Therefore, the thickness of the dielectric supporting member 43 is preferably set so as to have a requisite minimum value.

Now, a fabrication method of the high frequency module according to the present embodiment is described.

First, the package unit 6 including the back short 3, semiconductor chip 4 and antenna coupler 5 is fabricated (step of fabricating the package unit).

In particular, the back short 3 and the semiconductor chip 4 are integrated first by the resin 7. Then, the redistribution line 8 is provided such that the antenna coupler 5 and the semiconductor chip 4 are electrically coupled with each other.

Here, where the package unit 6 having the configuration of the embodiment described above is to be fabricated, the dielectric supporting member 43 to support the antenna coupler 5 is provided first in the region 30, namely, in a space, defined by the bottom portion 22A and the frame-shaped side portion 22B of the bathtub-shaped metal member 22. Thereafter, in the step of integrating by the resin 7, the bathtub-shaped metal member 22 having the bottom portion 22A that functions as the back short 3 and the frame-shaped side portion 22B and the semiconductor chip 4 are integrated by the resin 7. Then, in the step of providing the redistribution line 8, the redistribution line 8 is provided so as to extend to a region over the back short 3 and include the portion 8X that functions as the antenna coupler 5.

Where the package unit 6 is fabricated in such a manner as described above, the step of providing the redistribution line 8 includes a step of providing the dielectric film 31 having the conductor layer 33A on the resin 7, another step of forming the via 32 on the dielectric film 31, and a further step of forming the line conductor 33 by patterning the conductor layer 33A. For example, patterning the redistribution line 8 after the dielectric film 31 having the conductor layer 33A is attached to the resin 7 of the integrated body is included in this. It is to be noted that whichever one of the step of forming the via 32 and the step of forming the line conductor 33 may be performed earlier.

Then, the package unit 6 fabricated in such a manner as described above is attached to the metal housing 2 including the waveguide 1 such that the back short 3 is positioned on an extension of the waveguide 1 and the antenna coupler 5 is positioned between the waveguide 1 and the back short 3.

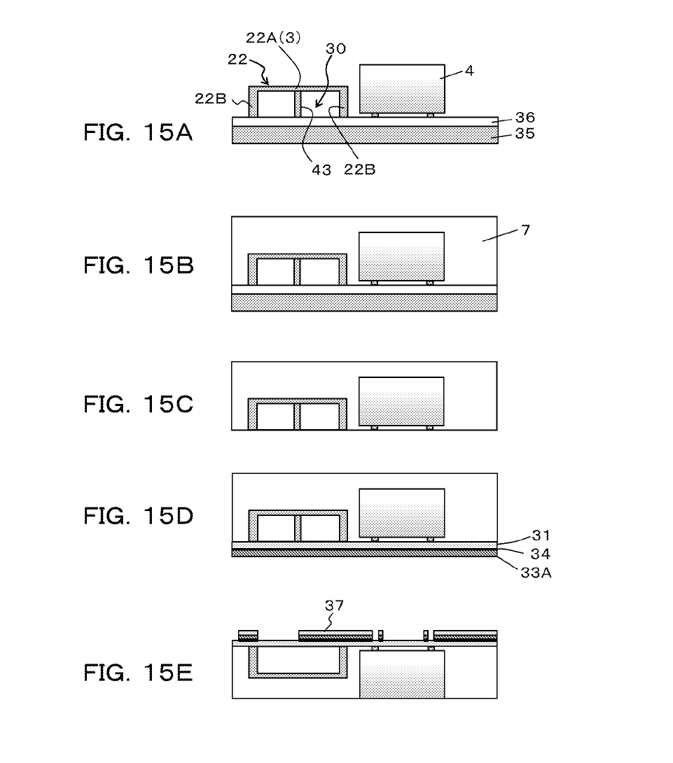

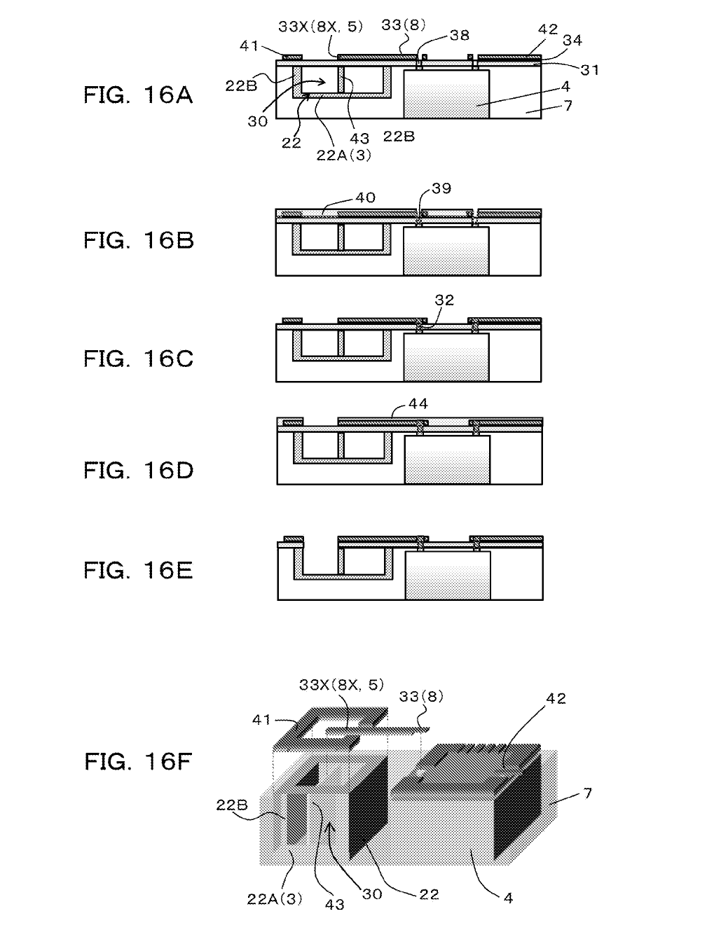

In the following, description is given with reference to FIGS. 15A to 15E and 16A to 16F taking, as an example, a case in which the plate-shaped dielectric supporting member 43 is used, the dielectric film 31 to which the metal layer 33A is adhered through the adhesive layer 34 is laminated (bonded) on the resin 7 of the integrated body and then the metal layer 33A is patterned and the via 32 is formed on the dielectric film 31 to provide the redistribution line 8, whereafter the dielectric film 31 around the antenna coupler 5 is removed.

First, the back short 3 and the semiconductor chip 4 are integrated by the resin 7 as depicted in FIGS. 15A to 15C.

In particular, the dielectric supporting member 43 to support the antenna coupler 5 is provided in the region 30, namely, in a space, defined by the bottom portion 22A and the frame-shaped side portion 22B of the bathtub-shaped metal member 22 as depicted in FIG. 15A. More particularly, the plate-shaped low dielectric material supporting member 43 is disposed at a position at which the plate-shaped low dielectric material supporting member 43 can support a tip end of the antenna coupler 5 in the region 30, namely, in a space, defined by the bottom portion 22A and the frame-shaped side portion 22B of the bathtub-shaped metal member 22 made of, for example, copper or aluminum.

Then, the bathtub-shaped metal member 22 that has the bottom portion 22A that functions as the back short 3 and the frame-shaped side portion 22B and includes the dielectric supporting member 43 provided in the inside of the bathtub-shaped metal member 22 (space) defined by the bottom portion 22A and the frame-shaped side portion 22B, and the semiconductor chip 4 are disposed on a pressure-sensitive adhesive face of the pressure-sensitive adhesive film 36 provided on the supporting body 35. In particular, the bathtub-shaped metal member 22 on which the dielectric supporting member 43 is provided and the semiconductor chip 4 are temporarily fixed to desired positions on the pressure-sensitive adhesive film 36 provided on the supporting body 35 in a facedown posture in which the opening of the bathtub-shaped metal member 22 and the circuit face of the semiconductor chip 4 are directed downwardly. It is to be noted that the pressure-sensitive adhesive film 36 is referred to also as slightly pressure-sensitive adhesive sheet.

Then, the bathtub-shaped metal member 22 in the inside of which the dielectric supporting member 43 is provided and the semiconductor chip 4 are buried with the resin 7 and integrated by the resin 7 (for example, epoxy-based resin) as depicted in FIG. 15B.

Then, the supporting body 35 and the pressure-sensitive adhesive film 36 are detached as depicted in FIG. 15C.

An integrated body (pseudo wafer) molded using resin composition is fabricated in this manner.

Then, the redistribution line 8 is provided such that the antenna coupler 5 and the semiconductor chip 4 are electrically coupled with each other as depicted in FIGS. 15D to 15E and 16A to 16C. Here, the redistribution line 8 is provided so as to extend to a region over the back short 3 and include the portion 8X that functions as the antenna coupler 5.

In particular, the integrated body fabricated in such a manner as described above is laminated on the dielectric film 31 to which the metal layer 33A (for example, copper foil) is adhered through the adhesive layer 34 as depicted in FIG. 15D.

Then, patterning is performed using, for example, the dry film resist 37 as depicted in FIG. 15E, and then, the metal layer 33A is etched and the via hole 38 is formed in the dielectric film 31 using a laser as depicted in FIG. 16A.

Then, after the dry film resist 37 is detached, the seed layer 39 made of, for example, copper or copper alloy is formed by sputtering or electroless plating and the resist 40 is patterned as depicted in FIG. 16B.

Then, the seed layer 39 is used to plate copper, for example, by electric plating to form the via 32 on the via hole 38, and then, after the resist 40 (photoresist) is detached, the seed layer 39 remaining under the resist 40 is removed, for example, by wet etching or dry etching as depicted in FIG. 16C.

The redistribution line 8 configured from the cooper line 33 (metal line; line conductor) electrically coupled with the semiconductor chip 4 through the via 32 formed in the dielectric film 31 provided on the mold resin 7 is provided in this manner. Further, the redistribution line 8 is formed so as to extend to the region over the back short 3 and include the redistribution line 8 that functions as the antenna coupler 5.

Then, the dielectric film 31 in a region other than the portion 8X of the antenna coupler 5 (here, the portion 33X of the line conductor 33) configured from the redistribution line 8 (here, the line conductor 33) provided on the dielectric film 31, namely, the dielectric film 31 around the antenna coupler 5, is removed as depicted in FIGS. 16D to 16F.

In particular, resist 44 is patterned to selectively expose the dielectric film 31 in the region other than the portion 8X of the antenna coupler 5 over the back short 3 that is the bottom portion 22A of the bathtub-shaped metal member 22 as depicted in FIG. 16D.

For example, a phenol-based photosensitive resin is applied by spin coating such that it has a thickness of, for example, 4 μm, and is exposed by a contact aligner or the like, and then development is performed using, for example, tetramethylammonium hydroxide (TMAH). Consequently, the dielectric film 31 in a region other than the portion 8X of the antenna coupler 5 over the back short 3 that is the bottom portion 22A of the bathtub-shaped metal member 22 is selectively exposed.

Then, the dielectric film 31 exposed selectively is removed by dry etching using, for example, mixture gas of CF₄ and O₂ so that the region over the back short 3 that is the bottom portion 22A of the bathtub-shaped metal member 22 is opened as depicted in FIGS. 16E and 16F. Then, the resist 44 is removed. For example, the resist 44 may be dissolved into and removed by solvent such as, for example, acetone.

The antenna coupler 5 configured from the redistribution line 8 (here, the line conductor 33) provided on the dielectric film 31 projects over the region 30, namely, the space, defined by the bottom portion 22A and the frame-shaped side portion 22B of the bathtub-shaped metal member 22 and is supported by the dielectric supporting member 43, and the surrounding region of the antenna coupler 5 exhibits an open state.

It is to be noted that particulars of the other part are similar to those in the case of the second embodiment and the modification described above.

Accordingly, with the high frequency module and the fabrication method for the frequency module according to the present embodiment, there is an advantage that degradation of a high frequency characteristic when a high frequency signal is transmitted between the waveguide tube 1 and the semiconductor chip 4 can be reduced similarly as in the case of the second embodiment and the modification described above.

It is to be noted that, although, in the embodiment described above, the redistribution line 8 (here, including the portion 8X that functions as the antenna coupler 5) is provided by providing the dielectric film 31 including the conductor layer 33A (metal layer, for example, copper foil) on the resin 7 of the integrated body, patterning the conductor layer 33A to form the line conductor 33 (here, including also the portion 33X that functions as the antenna coupler 5) and forming the via 32 on the dielectric film 31, the provision of the redistribution line 8 is not limited to this.

In particular, the redistribution line may be provided, for example, by providing a dielectric film including the via and the line conductor coupled to the via on the resin of the integrated body. This includes, for example, attachment of a dielectric film on which the line conductor and the via as the redistribution line are patterned to the resin of the integrated body. In short, adhesion of the dielectric film on which the line conductor and the via as the redistribution line are patterned to the resin of the integrated body using adhesive is included. In this case, it is preferable to use conductive adhesive to adhere the via patterned on the dielectric film and a region of the dielectric film in the proximity of the via and use low-dielectric and low-loss adhesive to adhere the other region of the dielectric film. However, if the cost and the mounting accuracy are taken into consideration, then it is preferable to provide the redistribution line in such a manner as in the embodiment described hereinabove. In this case, in the step of providing the redistribution line, the dielectric film including the via and the line conductor coupled to the via are provided on the resin.

All examples and conditional language recited herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A high frequency module, comprising:
a metal housing including a waveguide; and
a package unit that includes a back short positioned on an extension of the waveguide, a semiconductor chip, and an antenna coupler positioned between the waveguide and the back short and in which the back short and the semiconductor chip are integrated by resin and the antenna coupler and the semiconductor chip are electrically coupled with each other by a redistribution line.

2. The high frequency module according to claim 1, wherein the back short is a back face conductor layer provided on a back face of a multilayer dielectric substrate;
the antenna coupler is a front face conductor layer provided on a front face at the opposite side to the back face of the multilayer dielectric substrate; and
the multilayer dielectric substrate and the semiconductor chip are integrated by the resin.

3. The high frequency module according to claim 1, wherein the back short is a conductor layer provided on a back face of a multilayer dielectric substrate;
the antenna coupler is a portion of the redistribution line extending to a region between the waveguide and the back short; and
the multilayer dielectric substrate and the semiconductor chip are integrated by the resin.

4. The high frequency module according to claim 1, wherein the back short is a bottom portion of a bathtub-shaped metal member having the bottom portion and a frame-shaped side portion;
the antenna coupler is a portion of the redistribution line extending to a region between the waveguide and the back short; and
the bathtub-shaped metal member and the semiconductor chip are integrated by resin.

5. The high frequency module according to claim 4, wherein a region of the bathtub-shaped metal member defined by the bottom portion and the frame-shaped side portion is filled up with a dielectric.

6. The high frequency module according to claim 1, wherein the redistribution line is configured from a line conductor electrically coupled with the semiconductor chip through a via provided in a resin layer provided on the resin.

7. The high frequency module according to claim 1, wherein the redistribution line is configured from a line conductor electrically coupled with the semiconductor chip through a via provided in a dielectric film provided on the resin.

8. The high frequency module according to claim 4, wherein a region of the bathtub-shaped metal member defined by the bottom portion and the frame-shaped side portion is provided as a space; and
the redistribution line is configured from a line conductor electrically coupled with the semiconductor chip through a via provided in a dielectric film provided on the resin.

9. The high frequency module according to claim 7, wherein the dielectric film is made of a material selected from a group of benzocyclobutene, liquid crystal polymer, cycloolefin polymer, polyolefin, polyphenylene ether, polystyrene and a fluororesin represented by polytetrafluoroethylene.

10. The high frequency module according to claim 8, further comprising a dielectric supporting member that supports the antenna coupler in a region of the bathtub-shaped metal member defined by the bottom portion and the frame-shaped side portion of the bathtub-shaped metal member.

11. The high frequency module according to claim 10, wherein the dielectric supporting member is made of a material selected from a group of benzocyclobutene, liquid crystal polymer, cycloolefin polymer, polyolefin, polyphenylene ether, polystyrene and a fluororesin represented by polytetrafluoroethylene.

12. The high frequency module according to claim 10, wherein the dielectric supporting member is in the form of a plate, a frame or a pillar.

13. A fabrication method for a high frequency module, comprising:
fabricating a package unit including a back short, a semiconductor chip and an antenna coupler; and
attaching the package unit to a metal housing including a waveguide such that the back short is positioned on an extension of the waveguide and the antenna coupler is positioned between the waveguide and the back short; and wherein
the fabricating the package unit includes:
integrating the back short and the semiconductor chip by resin; and
providing a redistribution line such that the antenna coupler and the semiconductor chip are electrically coupled with each other.

14. The fabrication method for a high frequency module according to claim 13, wherein, in the integrating by the resin, a multilayer dielectric substrate including a back face conductor layer that serves as the back short on a back face thereof and a front face conductor layer that serves as the antenna coupler on a front face at the opposite side to the back face thereof and the semiconductor chip are integrated by the resin.

15. The fabrication method for a high frequency module according to claim 13, wherein, in the integrating by the resin, a multilayer dielectric substrate including a conductor layer that serves as the back short on a back face thereof and the semiconductor chip are integrated with the resin; and
in the providing the redistribution line, the redistribution line is provided so as to extend to a region over the back short such that a portion thereof that functions as the antenna coupler is included.

16. The fabrication method for a high frequency module according to claim 13, wherein, in the integrating by the resin, a bathtub-shaped metal member including a bottom portion that serves as the back short and a frame-shaped side portion and the semiconductor chip are integrated by the resin; and
in the providing the redistribution line, the redistribution line is provided so as to extend to a region over the back short such that a portion thereof that functions as the antenna coupler is included.

17. The fabrication method for a high frequency module according to claim 16, wherein a region of the bathtub-shaped metal member defined by the bottom portion and the frame-shaped side portion is provided as a space; and
the fabricating the package unit includes providing a dielectric supporting member to support the antenna coupler in a region of the bathtub-shaped metal member defined by the bottom portion and the frame-shaped side portion.

18. The fabrication method for a high frequency module according to claim 13, wherein the providing the redistribution line includes:
forming a resin layer on the resin;
forming a via in the resin layer; and
forming a line conductor on the resin layer.

19. The fabrication method for a high frequency module according to claim 13, wherein the providing the redistribution line includes:
providing a dielectric film including a conductor layer on the resin;
forming a via in the dielectric film; and
forming a line conductor by patterning the conductor layer.

20. The fabrication method for a high frequency module according to claim 13, wherein, in the providing the redistribution line, a dielectric film including a via and a line conductor coupled with the via is provided on the resin.
